(19) United States
(12) Patent Application Publication
(10) Pub. No.: US 2017/0233253 A1
(43) Pub. Date: Aug. 17, 2017

(54) CARBON NANOTUBE STRUCTURE AND PREPARATION METHOD THEREOF

(71) Applicant: Korea Institute of Science and Technology, Seoul (KR)

(72) Inventors: Kahyun HUR, Seoul (KR); Seungyeol JEON, Seoul (KR)

(73) Assignee: Korea Institute of Science and Technology, Seoul (KR)

(21) Appl. No.: 15/421,487

(22) Filed: Feb. 1, 2017

(30) Foreign Application Priority Data
Feb. 16, 2016 (KR) 10-2016-0017539

(51) Int. Cl. C01B 31/04; C08J 5/12

(52) U.S. Cl. CPC C01B 31/028; C08J 5/121; C01B 2202/08; C01B 2202/22; B82Y 40/00

(57) ABSTRACT

The present invention relates to a carbon nanotube structure and the preparation method thereof for easily controlling a Poisson's ratio. The carbon nanotube structure according to the present invention includes a plurality of carbon nanotubes that are tilted at a predetermined angle with respect to a direction of a first axis to which tension is applied and aligned. Here, a negative Poisson's ratio can be changed by controlling a tilt angle of the plurality of carbon nanotubes.

### CROSS-REFERENCE TO RELATED APPLICATION

This application claims priority to and the benefit of Korean Patent Application No. 10-2016-0017539 filed in the Korean Intellectual Property Office on Feb. 16, 2016 respectively, the entire contents of which are incorporated herein by reference.

The present invention relates to a carbon nanotube structure and the preparation method thereof, and more particularly, to a carbon nanotube structure and the preparation method thereof by which a Poisson's ratio can be easily controlled.

A Poisson's ratio is the ratio of transverse deformation to axial deformation when a vertical stress is applied to a material. The Poisson's ratio is an important consideration for understanding deformation in an elastic deformation region as an indicator of the strength of the material.

Most materials have a positive Poisson's ratio in which a material contracts transversally when axially stretched, and conversely, expands transversally when axially compressed.

Further, auxetic materials are defined as materials having a negative Poisson's ratio. The auxetic materials having a negative Poisson's ratio act in a manner opposite to materials having a positive Poisson's ratio. That is, materials are transversally expanded when axially stretched, and transversally contracted when axially compressed.

Japanese Patent No. 5368366 discloses a structure having a positive or negative Poisson's ratio. This patent document discloses a structure that is prepared by crossing two layers of carbon nanotube sheets aligned in one direction at an angle of 0 to 90 degrees and stacking them, and a composite material that is formed using a variety of polymers as a base material to increase the elasticity and flexibility of the structure. According to this patent document, it is possible to control a Poisson's ratio to be positive or negative depending on the crossing angle between the two layers of the carbon nanotube sheets aligned in one direction.

However, this patent document does not disclose the characteristics of a Poisson's ratio according to the crossing angle between the two layers of the carbon nanotube sheets. Furthermore, the structure disclosed in this patent document acts in a manner in which a Poisson's ratio changes from a positive Poisson's ratio to a negative Poisson's ratio or from a negative Poisson's ratio to a positive Poisson's ratio depending on the elongation. According to this manner, it is difficult to define a Poisson's ratio with respect to a specific structure, and artificial control of the Poisson's ratio is not easy.

### PRIOR ART DOCUMENT

### Patent Document

Japanese Patent No. 5368366 (Sep. 20, 2013)

The present invention is directed to providing a carbon nanotube structure and the preparation method thereof, by which a Poisson's ratio can be easily controlled.

The present invention is also directed to providing a carbon nanotube structure and the preparation method thereof, by which a Poisson's ratio can be easily controlled by adjusting the angle between the alignment direction and the elongation direction of carbon nanotubes in a carbon nanotube sheet in which carbon nanotubes are aligned in one direction.

One aspect of the present invention provides a carbon nanotube structure including a plurality of carbon nanotubes that are tilted at a predetermined angle with respect to a direction of a first axis to which tension is applied. Here, a negative Poisson's ratio may be changed by controlling a tilt angle of the plurality of carbon nanotubes.

In the carbon nanotube structure according to the present invention, the tilt angle (θ) of the plurality of carbon nanotubes may be 0<θ≦45°.

In the carbon nanotube structure according to the present invention, the negative Poisson's ratio has a maximum value at a specific angle between 0<θ≦45°, and increases at an angle in the range from 0 degree to a specific angle, and decreases at an angle in the range from the specific angle to 45°.

In the carbon nanotube structure according to the present invention, the negative Poisson's ratio may have a maximum value at a specific angle between 15°≦θ≦25°.

In the carbon nanotube structure according to the present invention, when the plurality of carbon nanotubes are tilted at a predetermined angle in a direction of a second axis perpendicular to the first axis, the plurality of the carbon nanotubes have a negative Poisson's ratio with respect to a third axis perpendicular to the first and second axes and have a positive Poisson's ratio with respect to the direction of the second axis.

The carbon nanotube structure according to the present invention may be in a sheet form in which the first axis is a longitudinal direction, the second axis is a width direction, and the third axis is a thickness direction.

In the carbon nanotube structure according to the present invention, a Poisson's ratio may have a maximum of −2.5 at an elongation of 2% or less.

The present invention also provides a method of preparing a carbon nanotube structure, which includes preparing a carbon nanotube sheet by drawing and packing a superaligned carbon nanotube array; and preparing a carbon nanotube structure by cutting the carbon nanotube sheet such that the carbon nanotubes of the carbon nanotube sheet are tilted at a predetermined angle with respect to a direction of a first axis to which tension is applied and aligned.

In the method of preparing the carbon nanotube structure according to the present invention, the drawn carbon nanotube sheet is passed through an organic solvent to prepare a carbon nanotube sheet packed by capillary action in the preparation of the carbon nanotube sheet.

In the method of preparing the carbon nanotube structure according to the present invention, the organic solvent may include ethanol or acetone.

In the method of preparing the carbon nanotube structure according to the present invention, the packed carbon nanotube sheet may be cut by an ion beam milling or microtoming method in the preparation of the carbon nanotube structure.

The present invention also provides an electrode including a polymer film and a carbon nanotube structure. The polymer film has a first surface, and a second surface opposite to the first surface. Further, the carbon nanotube structure is attached to at least one surface of the first surface and the second surface of the polymer film.

In the electrode according to the present invention, the carbon nanotube structure may include a first carbon nanotube structure attached to the first surface of the polymer film; and

a second carbon nanotube structure attached to the second surface of the polymer film.

In the electrode according to the present invention, the polymer film may include polyvinylidene difluoride (PVDF).

Furthermore, in the electrode according to the present invention, the carbon nanotube structure may be attached to the polymer film by thermocompression.

According to the present invention, the carbon nanotube structure of the present invention has a negative Poisson's ratio due to having a structure where carbon nanotubes are tilted at a predetermined angle with respect to the elongation direction and aligned. Moreover, the carbon nanotube structure according to the present invention can allow a negative Poisson's ratio to be easily controlled by adjusting an angle, that is, a direction of alignment of carbon nanotubes with respect to the elongation direction.

The carbon nanotube structure according to the present invention has an advantage of being easily prepared by a simple process of cutting a carbon nanotube sheet on which carbon nanotubes are aligned in a line such that the carbon nanotubes are tilted at a predetermined angle in the elongation direction.

The present invention is also advantageous in that an aligned carbon nanotube structure can be realized which has a uniform and highly negative Poisson's ratio with a maximum of about −2.5 at a low elongation of 2% or less.

Furthermore, the carbon nanotube structure according to the present invention is inherently usable as an electrode material in various fields because of high electrical conductivity. For example, PVDF (polyvinylidene difluoride) is a polymer used as a piezoelectric element and easily thermally processed due to having thermoplasticity. The PVDF generates energy by different mechanisms with respect to each of external elongation and compression. When a composite of “carbon nanotube structure/PVDF/carbon nanotube structure” is formed using the aligned carbon nanotube structure having a negative Poisson's ratio according to the present invention, the PVDF generates energy due to elongation while a pair of carbon nanotube structures are compressed due to characteristics of a negative Poisson's ratio. Accordingly, since additional energy can be generated due to compression, the composite according to the present invention is expected to have piezoelectric characteristics superior to those of the conventional “PVDF/metal” composite.

### BRIEF DESCRIPTION OF DRAWINGS

FIG. 1 is a flow chart according to a preparation method of the carbon nanotube structure according to the present invention.

FIGS. 2 to 4 are images showing each step according to the preparation method of FIG. 1.

FIG. 5 is an image showing a carbon nanotube structure tilted at a predetermined angle in a direction of an x-axis according to a first embodiment of the present invention.

FIGS. 6A and 6B are an image showing carbon nanotubes tilted at a predetermined angle in the direction of the x-axis of FIG. 5.

FIGS. 7A and 7B are an image showing a state in which a width of the carbon nanotube structure of FIG. 5 is reduced in a direction of an x-axis when the carbon nanotube structure of FIG. 5 is stretched in a direction of a z-axis.

FIGS. 8A and 8B are an image showing a state in which a thickness of the carbon nanotube structure of FIG. 5 is increased in a direction of a y-axis when the carbon nanotube structure of FIG. 5 is stretched in the direction of the z-axis.

FIGS. 9A and 9B are an image showing a carbon nanotube structure in which carbon nanotubes are tilted at a predetermined angle in the direction of the y-axis according to a second embodiment of the present invention.

FIG. 10 is an image showing a carbon nanotube sheet according to simulations.

FIG. 11 is an image showing carbon nanotube structures tilted in the directions of the x-axis and y-axis according to the simulations.

FIG. 12 is a graph showing a change in a positive Poisson's ratio of the carbon nanotube structure according to the first embodiment of the present invention in accordance with a tilt angle in the direction of the x-axis in the simulations.

FIG. 13 is a graph showing a change in a negative Poisson's ratio of the carbon nanotube structure according to the first embodiment of the present invention in accordance with a tilt angle in the direction of the x-axis in the simulations.

FIG. 14 shows images illustrating a method of preparing an electrode according to a third embodiment of the present invention, where the electrode includes the carbon nanotube structure according to the first embodiment of the present invention.

FIG. 15A to 15C are an image showing a state in which tensile and compressive forces are independently applied to an electrode according to a comparative example.

FIG. 16 is an image showing a state in which tensile and compressive forces are applied to an electrode at the same time according to the third embodiment of the present invention.

### DETAILED DESCRIPTION

In the following description, detailed descriptions of well-known functions or configurations will be omitted since they would obscure the invention with unnecessary detail.

It should be understood that the terms used in the specification and the appended claims should not be construed as limited to general and dictionary meanings, but should be interpreted based on the meanings and concepts corresponding to technical aspects of the present invention on the basis of the principle that the inventor is allowed to define terms appropriately for the best explanation. Therefore, the description proposed herein is just a preferable example for the purpose of illustration only, and is not intended to limit the scope of the invention, so it should be understood that other equivalents and modifications could be made thereto without departing from the spirit and scope of the invention.

Hereinafter, exemplary embodiments of the present invention will be described in detail.

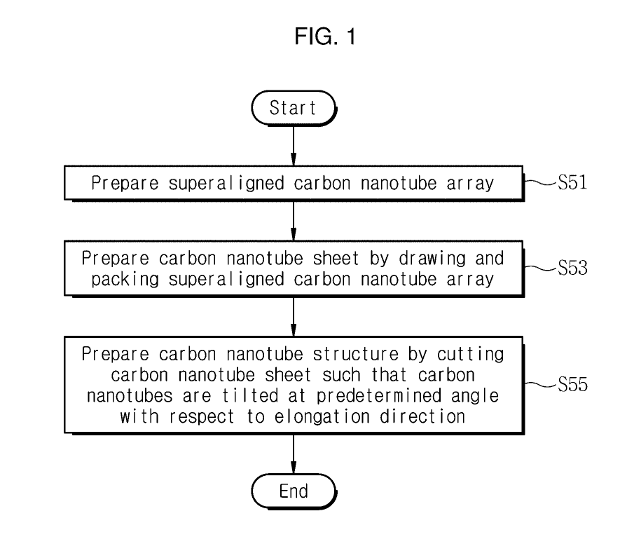

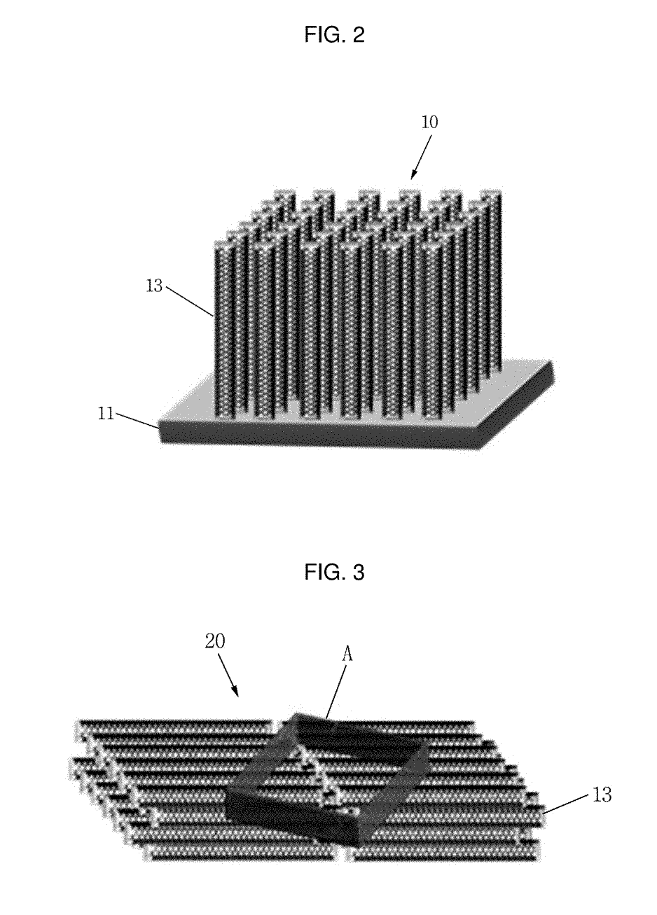

First, a method of preparing the carbon nanotube structure according to the present invention will be described with reference to FIGS. 1 to 4 as follows. Here, FIG. 1 is a flow chart according to a preparation method of the carbon nanotube structure according to the present invention. FIGS. 2 to 4 are images showing each step according to the preparation method of FIG. 1.

As illustrated in FIG. 2, a superaligned carbon nanotube array (superaligned CNT array) 10 is prepared in step S51. That is, the superaligned carbon nanotube array 10 is prepared by forming carbon nanotubes 13 on a wafer 11 formed of silicon through a deposition process.

Here, examples of the wafer 11 of the superaligned carbon nanotube array 10 may include a p-type silicon wafer, an n-type silicon wafer or a silicon wafer having a surface on which an oxide layer is formed. The carbon nanotubes 13 of the superaligned carbon nanotube array 10 may be single-walled carbon nanotubes, double-walled carbon nanotubes or multi-walled carbon nanotubes. As the deposition method, a chemical vapor deposition (CVD) method may be used.

Next, as illustrated in FIGS. 2 and 3, a carbon nanotube sheet 20 is prepared by drawing and packing the superaligned carbon nanotube array 10 in step S53. Here, the drawn carbon nanotube sheet is passed through an organic solvent to prepare a carbon nanotube sheet 20 packed by capillary action. Examples of the organic solvent include ethanol or acetone, but are not limited thereto.

The carbon nanotube sheet 20 after undergoing the packing process has a structure where the carbon nanotubes 13 are aligned in one direction.

Further, as shown in FIGS. 3 and 4, the carbon nanotube structure 30 according to the present invention may be prepared by cutting the carbon nanotube sheet 20 such that the carbon nanotubes 13 are tilted at a predetermined angle with respect to the elongation direction in step S55. In other words, the carbon nanotube structure 30 according to the present invention may be prepared by obliquely cutting the carbon nanotube sheet 20 into a rectangular form at a predetermined angle with respect to the alignment direction of the carbon nanotubes. For example, when the elongation direction is a direction of a z-axis in an xyz coordinate system, the carbon nanotube structure 30 may be prepared to have carbon nanotubes 13 tilted in a direction of an x-axis or a y-axis. Here, an example of the cutting method includes an ion beam milling or microtoming method, but is not limited thereto. In FIG. 3, A represents a portion where the carbon nanotube sheet 20 is cut.

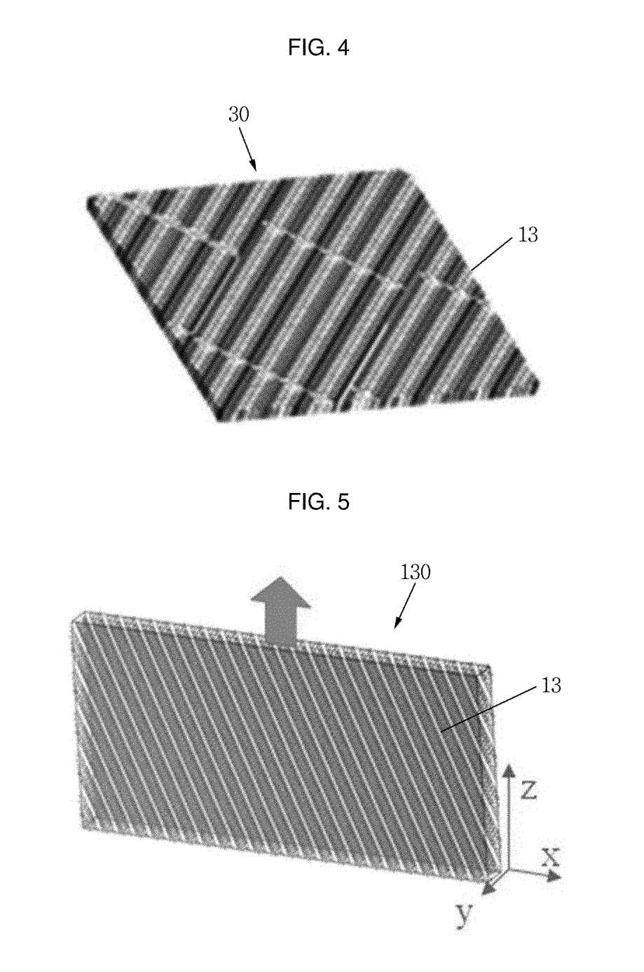

A carbon nanotube structure 130 tilted at a predetermined angle in a direction of an x-axis according to a first embodiment of the present invention will be described with reference to FIGS. 5 to 8 as follows.

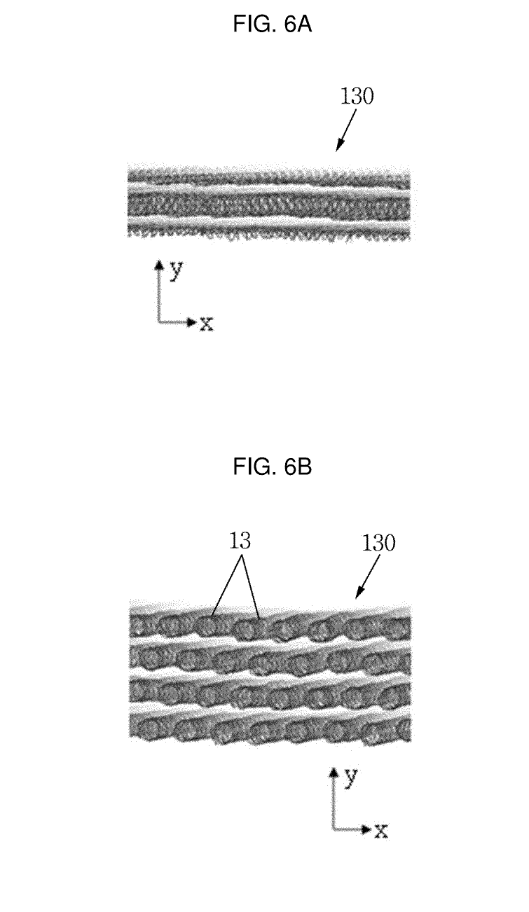

FIG. 5 is an image showing a carbon nanotube structure tilted at a predetermined angle in the direction of the x-axis according to the first embodiment of the present invention. FIG. 6 is an image showing carbon nanotubes 13 tilted at a predetermined angle in the direction of the x-axis of FIG. 5. Here, FIG. 6 is an image of the carbon nanotube structure 130 according to the first embodiment as viewed in an xy plane. In FIG. 6B is an enlarged view of FIG. 6A.

Referring to FIGS. 5 and 6, the carbon nanotube structure 130 according to the first embodiment is a three-dimensional structure in a sheet form in which the carbon nanotubes 13 are tilted at a predetermined angle in the direction of the x-axis.

That is, each of the carbon nanotubes 13 is positioned on an xz plane perpendicular to the y-axis, and tilted at a predetermined angle in the direction of the x-axis. Moreover, the carbon nanotubes 13 are arranged in multiple rows in the direction of the y-axis to be parallel to the direction of the x-axis.

In the carbon nanotube structure 130 according to the first embodiment, the direction of the y-axis is defined as a thickness direction, the direction of the x-axis is defined as a width direction, and the direction of the z-axis is defined as a longitudinal direction. Hereinafter, the description will be presented considering a case where the carbon nanotube structure 130 according to the first embodiment is positioned at the widest surface of the sheet on the xz plane.

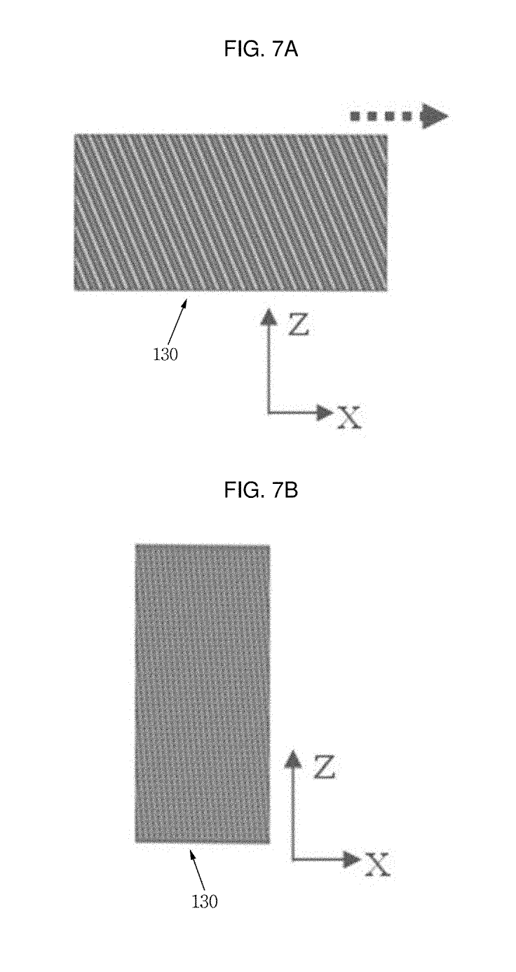

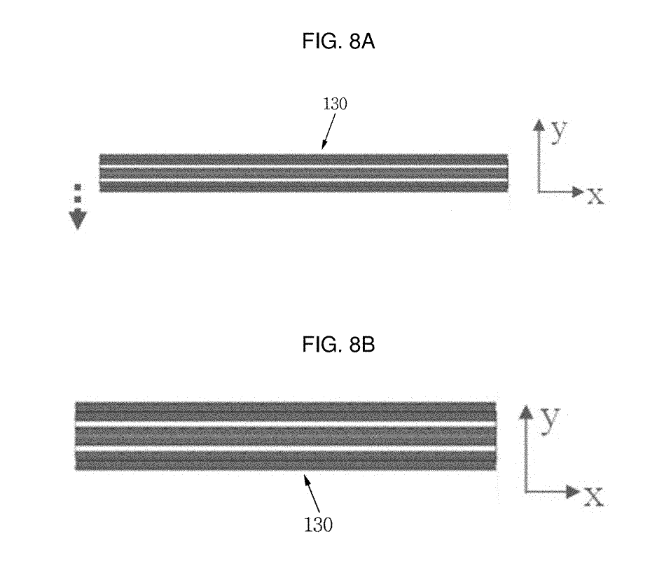

As such, when stretched in the direction of the z-axis, the carbon nanotube structure 130 according to the first embodiment which is tilted in the direction of the x-axis exhibits characteristics of a Poisson's ratio, according to FIGS. 7 and 8.

FIG. 7 is an image showing a state in which a width of the carbon nanotube structure 130 of FIG. 5 is reduced in the direction of the x-axis according to a positive Poisson's ratio when the carbon nanotube structure 130 of FIG. 5 is stretched in the direction of the z-axis. Here, FIG. 7 shows the carbon nanotube structure 130 on the xz plane, where FIG. 7A shows the carbon nanotube structure 130 before the elongation and FIG. 7B shows the carbon nanotube structure 130 after the elongation.

Referring to FIG. 7, when stretched in the direction of the z-axis, the carbon nanotube structure 130 according to the first embodiment has characteristics of having a length increased in the direction of the z-axis and a width decreased in the direction of the x-axis. That is, the carbon nanotube structure 130 according to the first embodiment has a positive Poisson's ratio with respect to the direction of the x-axis.

FIG. 8 is an image showing a state in which a thickness of the carbon nanotube structure 130 of FIG. 5 is increased in the direction of the y-axis according to a negative Poisson's ratio when the carbon nanotube structure 130 of FIG. 5 is stretched in the direction of the z-axis.

Here, FIG. 8 shows the carbon nanotube structure 130 on the xy plane, where FIG. 8A shows the carbon nanotube structure 130 before the elongation and FIG. 8B shows the carbon nanotube structure 130 after the elongation.

Referring to FIG. 8, when stretched in the direction of the z-axis, the carbon nanotube structure 130 according to the first embodiment has characteristics of having a thickness increased in the direction of the y-axis. That is, the carbon nanotube structure 130 according to the first embodiment has a negative Poisson's ratio with respect to the direction of the y-axis.

As such, when stretched in the direction of the z-axis, the carbon nanotube structure 130 according to the first embodiment has a positive Poisson's ratio with respect to the direction of the x-axis in which the carbon nanotubes 13 are tilted, and has a negative Poisson's ratio with respect to the direction of the y-axis.

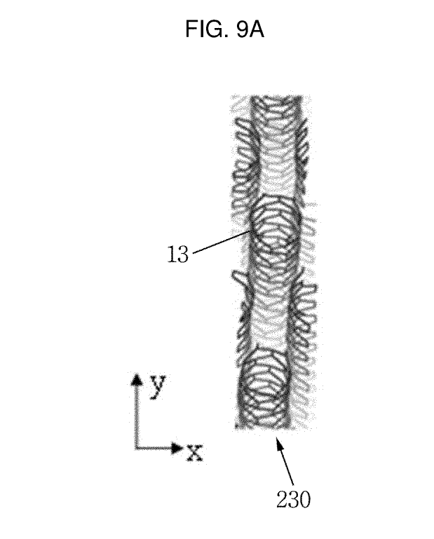

Although the carbon nanotube structure 130 tilted at a predetermined angle in the direction of the x-axis was described in the first embodiment, as illustrated in FIG. 9, a carbon nanotube structure 230 which is tilted at a predetermined angle in the direction of the y-axis according to a second embodiment may also be realized. Here, FIG. 9 shows the carbon nanotube structure 230 on the xy plane, where FIG. 9a shows the carbon nanotube structure 230 before the elongation and FIG. 9b shows the carbon nanotube structure 230 after the elongation.

Referring to FIG. 9, the carbon nanotube structure 230 according to the second embodiment is a three-dimensional structure in a sheet form in which the carbon nanotubes 13 are tilted at a predetermined angle in the direction of the y-axis.

When stretched in the direction of the z-axis, the carbon nanotube structure 230 according to the second embodiment has a positive Poisson's ratio with respect to the direction of the y-axis in which the carbon nanotubes 13 are tilted, and has a negative Poisson's ratio with respect to the direction of the x-axis.

As such, the carbon nanotube structure according to the present invention has a positive Poisson's ratio with respect to the direction in which the carbon nanotubes are tilted, and has a negative Poisson's ratio with respect to the direction perpendicular to the direction in which the carbon nanotubes are tilted and the direction in which the carbon nanotubes are stretched.

The following simulation was conducted in order to determine that a Poisson's ratio is changed according to the tilt angle of the carbon nanotubes with respect to the elongation direction in the above-described carbon nanotube structure according to the present invention.

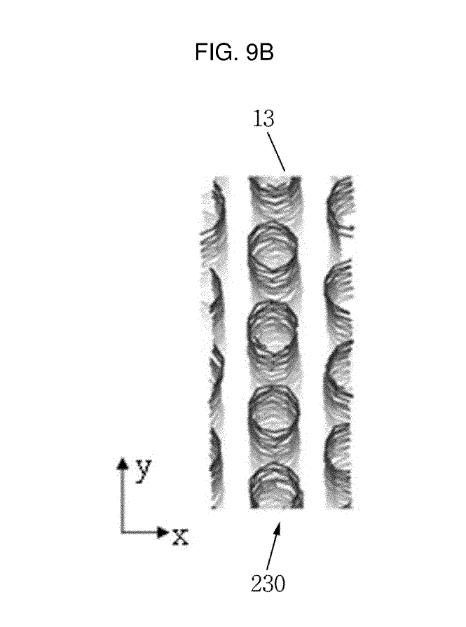

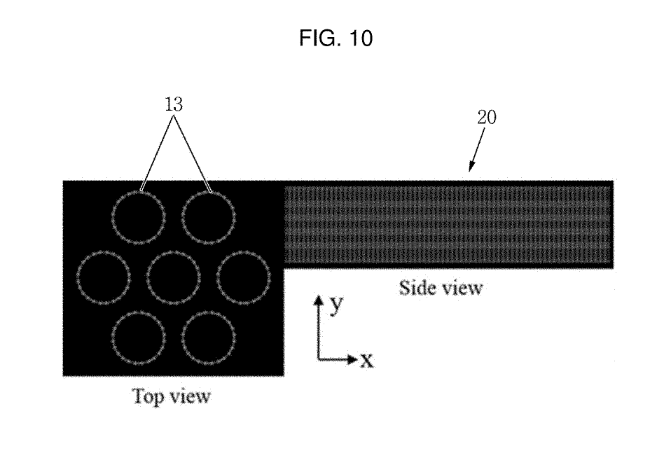

FIG. 10 is an image showing a carbon nanotube sheet 20 according to the simulation. FIG. 11 is an image showing carbon nanotube structures 130 and 230 tilted in the directions of the x-axis and y-axis according to the simulation.

Referring to FIG. 10, the carbon nanotubes 13 inside the carbon nanotube sheet 20 has a hexagonal closed packed structure. Here, a direction in which the carbon nanotubes 13 can be tilted with respect to the elongation direction may be set as the direction of the x-axis or the y-axis as shown in FIG. 11.

A change in a Poisson's ratio in accordance with the tilt angle of the carbon nanotubes 13 of the carbon nanotube structures 130 and 230 with respect to the elongation direction was calculated through the present simulation. As a method for calculating a change in a Poisson's ratio, a large-scale atomic/molecular massively parallel simulator (LAMMPS) package which is a molecular dynamics simulation tool was used.

Carbon nanotube structures 130 and 230 were designed by setting the angle (θ) of the carbon nanotubes 13 tilted in directions of the x-axis and y-axis with respect to the elongation direction to an angle between 0° to 45° (0<θ≦45°). The shape of the carbon nanotubes 13 varies according to the diameter and chirality of the carbon nanotubes, and the chirality is represented as (m, n) (m and n are integers). When m=n, the carbon nanotubes 13 have an armchair structure. When only n is 0, the carbon nanotubes 13 have a zig-zag structure. The higher the values of m and n, the thicker the diameter of the carbon nanotubes 13 is.

The carbon nanotube structure 130 was designed using the carbon nanotubes 13 each having a chirality of (4,4), (5,0), (5,5), (6,0) and (6,6) to calculate the effect of the Poisson's ratio depending on the type of the carbon nanotubes 13. Periodic boundary conditions were set in all directions (x, y and z (elongation direction)) of the carbon nanotube structure 130.

The adaptive intermolecular reactive empirical bond order (AIREBO) potential, which is most commonly used in the simulation of the carbon nanotube structure 130, was used for the simulation. A time interval of the simulation was set to 1.0 fs. First, a simulation was performed for the carbon nanotube structure 130 through the NPT (T=room temperature (300 K), P=0 Pa) ensemble for 100 ps for the process of stabilization of the structure and energy of the carbon nanotube structure 130. Then, a simulation was further performed for the stabilized carbon nanotube structure 130 through the NPT (P=0 Pa) ensemble in other directions except for the elongation direction (directions of x-axis and y-axis) while the stabilized carbon nanotube structure 130 was stretched at an elongation rate of 1 mm/sec in the direction of the z-axis.

After the elongation simulations for the carbon nanotube structure 130 tilted at various direction angles were carried out until an elongation reached 2%, Poisson's ratios for each case were calculated.

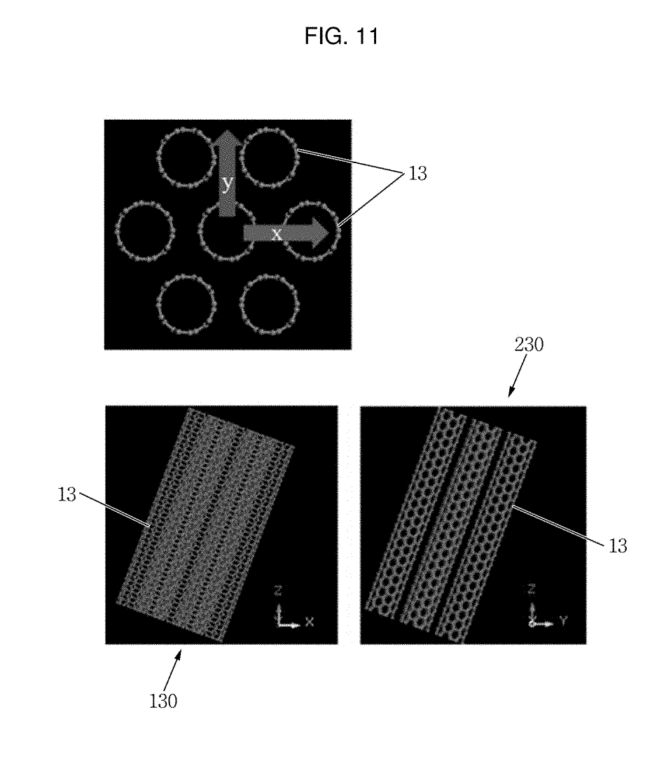

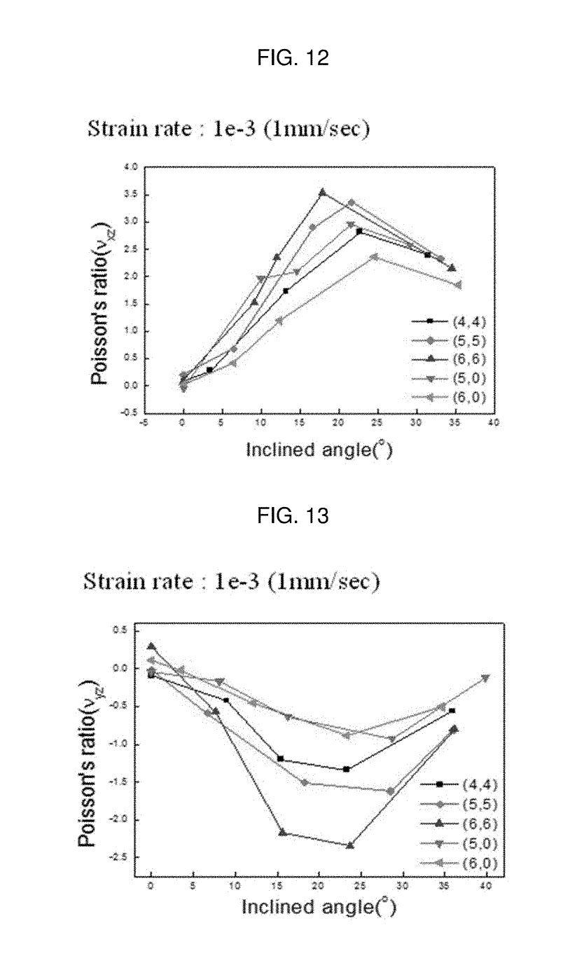

The results of these simulations are as shown in FIGS. 12 and 13. FIG. 12 is a graph showing a change in a positive Poisson's ratio of the carbon nanotube structure according to the first embodiment of the present invention in accordance with a tilt angle in a direction of an x-axis in a simulation. FIG. 13 is a graph showing a change in a negative Poisson's ratio of the carbon nanotube structure according to the first embodiment of the present invention in accordance with a tilt angle in a direction of an x-axis in a simulation. Here, FIGS. 12 and 13 are graphs illustrating a change in a Poisson's ratio according to the tilt angle of the carbon nanotube structure with respect to the elongation direction when stretched at an elongation rate of 1 mm/sec, based on the chirality (m, n) of the carbon nanotubes.

Referring to FIG. 12, the carbon nanotube structure according to the first embodiment exhibits a change in a positive Poisson's ratio in the direction of the x-axis, which is a width direction, depending on the tilt angle. Although there is a slight difference according to the diameter of the carbon nanotubes, it can be seen that a positive Poisson's ratio is maximum at a tilt angle between 0<θ≦45° with respect to the elongation direction. Particularly, it can be determined that a positive Poisson's ratio is maximum at a tilt angle between 15° to 25° (15°≦θ≦25°) with respect to the elongation direction. Also, it can be confirmed that a positive Poisson's ratio has a maximum value of about 3.5.

Referring to FIG. 13, the carbon nanotube structure according to the first embodiment exhibits a change in a negative Poisson's ratio in the direction of the y-axis, which is a thickness direction, depending on the tilt angle. Although there is a slight difference according to the diameter of the carbon nanotubes, it can be seen that a negative Poisson's ratio is maximum at a tilt angle between 0<θ≦45° with respect to the elongation direction. Particularly, it can be determined that a negative Poisson's ratio is maximum at a tilt angle between 15° to 25° (15°≦θ≦25°) with respect to the elongation direction. Also, it can be confirmed that a negative Poisson's ratio has a maximum value of about −2.5.

A case with an elongation rate of 1 mm/sec was described in these simulations, but the present invention is not limited thereto. That is, the inventors of the present invention determined the negative Poisson's ratio of the carbon nanotube structure of the present invention while setting an elongation rate to a specific rate between 0.01 to 1 mm/sec and extending the length of specimens to 2%. Moreover, characteristics similar to those of the negative Poisson's ratio as shown in FIG. 13 were determined even when an elongation rate is from 0.01 to 1 mm/sec.

That is, the carbon nanotube structure according to the present invention is determined to have a uniform and very high negative Poisson's ratio (maximum of −2.5) at a low elongation of 2% or less.

Furthermore, the carbon nanotube has a high electrical conductivity (about 750 S/cm or more, in the case of carbon nanotube fibers), and thus is inherently usable as an electrode material in various fields.

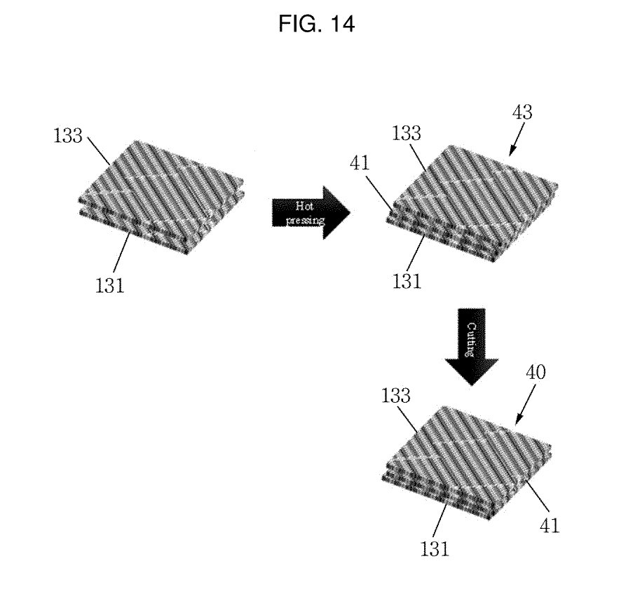

FIG. 14 shows images illustrating a method of preparing an electrode 40 according to a third embodiment of the present invention, where the electrode 40 includes carbon nanotube structures 131 and 133 according to the first embodiment of the present invention.

Referring to FIG. 14, the electrode 40 according to the third embodiment includes a polymer film 41, and carbon nanotube structures 131 and 133 according to the first embodiment which are attached to both sides of the polymer film 41.

The polymer film 41 has a first surface, and a second surface opposite to the first surface. A thermoplastic polymer material such as polyvinylidene difluoride (PVDF) may be used as the polymer film 41. The PVDF is a polymer used as a piezoelectric element and easily thermally processed due to having thermoplasticity. The PVDF has characteristics of generating energy by different mechanisms with respect to each of external elongation and compression.

Further, carbon nanotube structures 131 and 133 include a first carbon nanotube structure 131 attached to the first surface of the polymer film 41 and a second carbon nanotube structure 133 attached to the second surface of the polymer film 41.

Although carbon nanotube structures 131 and 133 are attached on both sides of the polymer film 41 in the present embodiment, the carbon nanotube structure may be attached to only one side.

The above-described electrode 40 according to the third embodiment electrode 40 may be prepared as follows. An electrode plate 43 is prepared by thermally compressing the polymer film 41 in a state in which the polymer film 41 is disposed between the first and second carbon nanotube structures 131 and 133. Thereafter, the electrode 40 according to the third embodiment may be obtained by cutting the electrode plate 43 into a size for use.

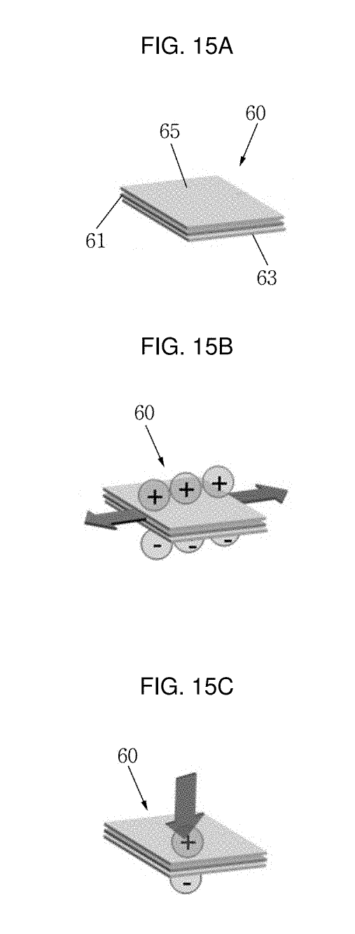

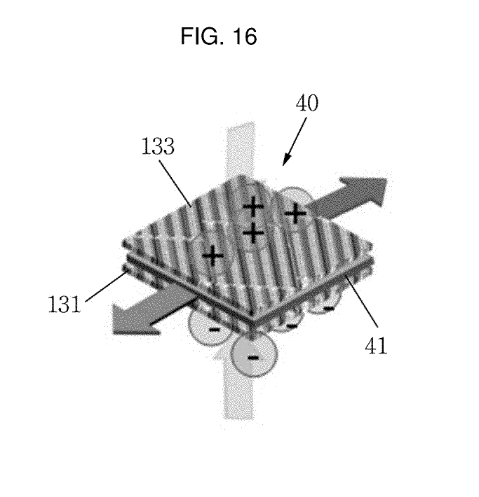

The characteristics of the electrode according to the third embodiment will be described with reference to FIGS. 15 and 16. Here, FIG. 15A to 15C are an image showing a state in which tensile and compressive forces are independently applied to an electrode 60 according to a comparative example. FIG. 16 is an image showing a state in which both of tensile and compressive forces are applied to the electrode 40 according to the third embodiment of the present invention.

Referring to FIG. 15A to 15C, an electrode 60 according to a comparative example has a structure where metal films 63 and 65 are attached to both sides of a polymer film 61. The metal films 63 and 65 include a first metal film 63 and a second metal film 65.

As illustrated in FIGS. 15B and 15C, elongation and compression are independently applied to the electrode 60 according to a comparative example. That is, when the electrode 60 according to the comparative example is stretched as shown in FIG. 15B, it is not compressed due to the elongation.

On the other hand, referring to FIG. 16, since the carbon nanotube structures 131 and 133 according to the first embodiment have a negative Poisson's ratio, the first and second carbon nanotube structures 131 and 133 both are compressed toward the polymer film 41 when the electrode 40 according to the third embodiment electrode 40 is stretched.

For example, when the electrode 40 is stretched in the direction of the z-axis, the thicknesses of the first and a second carbon nanotube structures 131 and 133 are increased in the direction of the y-axis. Accordingly, the polymer film positioned between the first and second carbon nanotube structures 131 and 133 in the direction of the y-axis are also compressed toward the polymer film 41.

When a composite of “carbon nanotube structure/PVDF/carbon nanotube structure” is formed by using the carbon nanotube structure having a negative Poisson's ratio according to the present invention as described above, the PVDF generates energy due to elongation while a pair of carbon nanotube structures are compressed toward the PVDF due to characteristics of a negative Poisson's ratio. Accordingly, since additional energy can be generated due to compression, the composite according to the present invention is expected to have piezoelectric characteristics superior to those of the conventional “PVDF/metal” (composite) electrode.

An example of the carbon nanotube structure applied to the electrode was described in in the present embodiment, but the present invention is not limited thereto. For example, the carbon nanotube structure is applicable to various uses such as prostheses, piezo-composites, filters, earphones, scaffolds, etc.

In addition, the examples shown in the present specification and the drawings are merely specific examples for ease of description, and are not intended to limit the scope of the present invention. It is clear to those skilled in the art that other modified examples may be performed besides the examples disclosed herein.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

What is claimed is:

1. A carbon nanotube structure, comprising a plurality of carbon nanotubes that are tilted at a predetermined angle with respect to a direction of a first axis to which tension is applied, wherein a negative Poisson's ratio is changed by controlling a tilt angle of the plurality of carbon nanotubes.

2. The carbon nanotube structure according to claim 1, wherein the tilt angle (θ) of the plurality of the carbon nanotubes is 0<θ≦45°.

3. The carbon nanotube structure according to claim 2, wherein the negative Poisson's ratio has a maximum value at a specific angle between 0<θ≦45°, increases at an angle in the range from 0 degree to a specific angle, and decreases at an angle in the range from the specific angle to 45°.

4. The carbon nanotube structure according to claim 2, wherein the negative Poisson's ratio has a maximum value at a specific angle between 15°≦θ≦25°.

5. The carbon nanotube structure according to claim 2, wherein, when the plurality of the carbon nanotubes are tilted at a predetermined angle in a direction of a second axis perpendicular to the first axis, the plurality of the carbon nanotubes have a negative Poisson's ratio with respect to a third axis perpendicular to the first and second axes and has a positive Poisson's ratio with respect to the direction of the second axis.

6. The carbon nanotube structure according to claim 5, which is in a sheet form in which the first axis is a longitudinal direction, the second axis is a width direction, and the third axis is a thickness direction.

7. The carbon nanotube structure according to claim 2, wherein a Poisson's ratio has a maximum of −2.5 at an elongation of 2% or less.

8. A method of preparing a carbon nanotube structure, comprising:
preparing a carbon nanotube sheet by drawing and packing a superaligned carbon nanotube array; and
preparing a carbon nanotube structure by cutting the carbon nanotube sheet such that carbon nanotubes of the carbon nanotube sheet are tilted at a predetermined angle with respect to a direction of a first axis to which tension is applied and aligned.

9. The method according to claim 8, wherein, in the preparation of the carbon nanotube sheet, the drawn carbon nanotube sheet is passed through an organic solvent to prepare a carbon nanotube sheet packed by capillary action.

10. The method according to claim 9, wherein the organic solvent includes ethanol or acetone.

11. The method according to claim 8, wherein, in the preparation of the carbon nanotube structure, the packed carbon nanotube sheet is cut by an ion beam milling or microtoming method.

12. An electrode, comprising:
a polymer film having a first surface, and a second surface opposite to the first surface; and
a carbon nanotube structure attached to at least one surface of the first surface and the second surface of the polymer film,
wherein the carbon nanotube structure includes a plurality of carbon nanotubes that are tilted at a predetermined angle with respect to a direction of a first axis to which tension is applied and aligned, and a negative Poisson's ratio is changed by controlling a tilt angle of the plurality of carbon nanotubes.

13. The electrode according to claim 12, wherein the carbon nanotube structure includes:
a first carbon nanotube structure attached to the first surface of the polymer film; and
a second carbon nanotube structure attached to the second surface of the polymer film.

14. The electrode according to claim 12, wherein the polymer film includes polyvinylidene difluoride (PVDF).

15. The electrode according to claim 12, wherein the carbon nanotube structure is attached to the polymer film by thermocompression.
